(19) United States
(12) Patent Application Publication
(10) Pub. No.: US 2020/0262714 A1
(43) Pub. Date: Aug. 20, 2020

(54) Synthesis of Lithium Titanate

(71) Applicant: Neomaterials Pty Ltd, West Perth (AU)

(72) Inventor: Christopher John Reed, Swanbourne (AU)

(21) Appl. No.: 16/646,534

(22) PCT Filed: Aug. 23, 2018
(86) PCT No.: PCT/AU2018/050899

§ 371 Date: Mar. 11, 2020

(30) Foreign Application Priority Data
Sep. 14, 2017 (AU) 2017903743

(51) Int. Cl. C01G 23/00; H01M 4/485; H01M 10/0525

(52) U.S. Cl. CPC C01G 23/005; H01M 4/485; H01M 10/0525; B82Y 40/00; C01P 2004/04; C01P 2002/72; C01P 2004/13

(57) ABSTRACT

A method for the synthesis of lithium titanate, the method comprising the method steps of: (i) reacting a source of titanium ions with a source of lithium ions at increased temperature in one or more reaction vessels for a period of time; and (ii) calcining the product of step (i) to produce a lithium titanate product having a nano-tube type crystal structure. An electrode material produced by the method of the invention and a lithium ion battery utilising the electrode material are also disclosed.

### FIELD OF THE INVENTION

The present invention relates to a method for the synthesis of lithium titanate having a nano-tube type crystal structure.

More particularly, the lithium titanate produced is intended for use, in one form, in lithium ion batteries.

The present invention further relates to a lithium ion battery utilising lithium titanate produced in accordance with the present invention. More particularly, the lithium titanate is utilised as an anode material in such a lithium ion battery.

### BACKGROUND ART

Most current methods employed to produce lithium titanate (Li₄Ti₅O₁₂) produce lithium titanate (Li₄Ti₅O₁₂) having an amorphous micro-grained structure with poor electrochemical performance. This type of crystal structure has poor cyclic capacity for lithium ion batteries during high drain. Consequently, lithium titanate (Li₄Ti₅O₁₂) has not been considered a good anode material.

Nano-scale materials with nano-particles, such as nanocrystals, spinel nanocrystals, nanowires, nano-sheets, together with their composites with conductive additives, have consequently been considered as anode materials for lithium-ion batteries (LIBs). Nanostructured electrode materials may have an increased effective surface area and a shortened path for lithium-ion migration. Further, nanostructured electrode materials may show better rate capability than their micro-grained counterparts.

Despite the above, disadvantages of known lithium titanate materials as electrode materials, particularly anode materials, are considered to include a low intrinsic ionic conductivity and low electronic conductivity, poor rate performance, and a low theoretical capacity.

The method and product of the present invention have as one object thereof to overcome substantially one or more of the above mentioned problems associated with the methods and products of the prior art, or to at least provide useful alternatives thereto.

The preceding discussion of the background art is intended to facilitate an understanding of the present invention only. This discussion is not an acknowledgement or admission that any of the material referred to is or was part of the common general knowledge as at the priority date of the application.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

Throughout the specification and claims, unless the context requires otherwise, the term “lithium titanate” is to be understood to refer to Li₄Ti₅O₁₂. Similarly, the abbreviation LTO is to be understood to refer to “lithium titanate” or Li₄Ti₅O₁₂.

### DISCLOSURE OF THE INVENTION

In accordance with the present invention there is provided a method for the synthesis of lithium titanate, the method comprising the method steps of:
(i) reacting anatase titanium dioxide (TiO₂) as a source of titanium ions, with LiOH.H₂O as a source of lithium ions, at increased temperature in one or more reaction vessels for a period of time; and
(ii) calcining the product of step (i) to produce a lithium titanate product having a nano-tube type crystal structure.

Preferably, the one or more reaction vessels of step (i) are provided in the form of one or more autoclaves, optionally one or more zirconium autoclaves.

Still preferably, the increased temperature of the reaction of step (i) is in the range of about 135° C. to 180° C.

Still further preferably, the period of time of the reaction of step (i) is a period of at least several hours. Yet still further preferably, the period of time of the reaction of step (i) is a period of greater than 12 hours, preferably about 24 hours.

Preferably, the calcining of step (ii) takes place at a temperature of at least 650° C. Still preferably, the calcining of step (ii) takes place at a temperature of about 700° C.

The calcining of step (ii) preferably takes place over a period of greater than 1 hour. Still preferably, the calcining of step (ii) takes place for a period of about 2 hours.

In accordance with the present invention there is further provided an electrode material for use in lithium ion batteries, the electrode material comprising lithium titanate produced by the method described hereinabove.

Preferably, the electrode material is provided in the form of an anode.

Still preferably, the capacity of the lithium titanate electrode material is in the range of 150˜170 mAh/g against lithium electrode potential. The charge capacity of greater than or equal to 150 mAh/g against lithium electrode potential is preferably able to be maintained over at least 40 cycles.

In accordance with the present invention there is still further provided a lithium ion battery comprising electrode material as described hereinabove.

In a preferred form of the invention the lithium ion battery comprises an anode comprising lithium titanate produced by the method described hereinabove.

In accordance with the present invention there is yet still further provided a lithium titanate in nano-tube type crystal form prepared by the method described hereinabove.

### BRIEF DESCRIPTION OF THE DRAWINGS

The present invention will now be described, by way of example only, with reference to the accompanying drawings, in which:

FIG. 1 is a first transmission electron microscopy (TEM) image of lithium titanate having a nano-tube type crystal structure having been synthesised in accordance with the method of the present invention;

FIG. 2 is a second transmission electron microscopy (TEM) image of lithium titanate having a nano-tube type crystal structure having been synthesised in accordance with the method of the present invention; and

FIG. 3 is a plot of discrete XRD peaks (each marked X) for the high purity lithium titanate (Li₄Ti₅O₁₂) produced by way of the experimental method of the present invention shown relative to the profile for a reference LTO (profile curve marked Y).

### BEST MODE(S) FOR CARRYING OUT THE INVENTION

The present invention provides a method for the synthesis of lithium titanate, the method comprising the method steps of:
(i) reacting a source of titanium ions with a source of lithium ions at increased temperature in one or more reaction vessels for a period of time; and
(ii) calcining the product of step (i) to produce a lithium titanate product.

The lithium titanate product of step (ii) advantageously is produced having a nano-tube type crystal structure.

The source of titanium ions used in step (i) is one of the group of titanium dioxide (TiO₂), titanic acid (H₄Ti₅O₁₂), and sodium titanate (Na₄Ti₅O₁₂), for example in a preferred form, titanium dioxide (TiO₂) in its anatase form.

The source of lithium ions used in step (i) is one of the group of LiOH.H₂O or Li₂CO₃ or LiCl or Li₂SO₄, for example in a preferred form, LiOH.H₂O.

The one or more reaction vessels of step (i) are provided in the form of one or more autoclaves, for example a single zirconium autoclave.

The increased temperature of the reaction of step (i) is in the range of between about 120° C. to 220° C., and preferably about 135° C. to 180° C. The period of time of the reaction of step (i) is a period of at least several hours, for example greater than about 12 hours, and preferably about 24 hours.

The calcining of step (ii) takes place at a temperature of at least 650° C., for example about 700° C. Further, the calcining of step (ii) takes place over a period of greater than 1 hour, for example between about 1 to 4 hours, and more particularly about 2 hours.

The present invention further provides an electrode material for use in lithium ion batteries, the electrode material comprising lithium titanate produced by the method described hereinabove. In one form of the invention, the electrode material is provided in the form of an anode.

The present invention still further provides a lithium ion battery comprising electrode material as described hereinabove.

### EXAMPLE 1

The reagents used for preparation of LTO by this example of the method of the present invention were LiOH.H₂O and anatase TiO₂.

First, a LiOH solution was prepared by dissolving 44.1 g LiOH.H₂O in 350 mL water in a plastic beaker. An amount of anatase TiO₂ powder (˜105 g, Sigma-Aldrich, USA), calculated on a stoichiometric basis, was added slowly to LiOH solution to prepare a homogeneous slurry under agitation. The prepared slurry was transferred (along with the washings of the beaker) to a Teflon lined autoclave container and the autoclave heated to the test temperatures. Once the set test temperatures (eg. 135° C. and 180° C.) were reached (after a period of less than 30 minutes), the reaction was continued for a further 24 hours. At the end of the test the autoclave was cooled and the slurry was transferred to a plastic container. As noted above, it is envisaged that a broad temperature range of about 120° C. to 220° C. is applicable.

The final cooled autoclave slurry was split into two halves. The first half of the slurry was centrifuged and the resulting solid was repulped once with deionised (DI) water. The repulped slurry was centrifuged and the solid obtained after decanting the wash liquor was dried in an oven, for example at 80° C. The dried solid was named as ‘Washed’ solid to differentiate from the solid from other half of the slurry. The centrifuged liquor was analysed for Li and Ti content.

The second half of the slurry was transferred to four Teflon beakers and dried at ˜110° C. in the presence of nitrogen gas. The solid obtained from the second half of the slurry was named “Unwashed” solid.

The Washed and Unwashed solids were further processed separately but in an otherwise identical way. Both the dried solids were ground in a mortar/pestle to achieve the following particle size distribution:
d10 =0.407 microns
d50 =0.86 micron
d80 =1.602 micron
d90 =2.659 micron

The ground and dried solids were then calcined/sintered in a muffle furnace at 700° C. for 2 h. The calcined/sintered solids were ground using mortar/pestle and submitted for characterisation study.

The final product was a high purity lithium titanate (Li₄Ti₅O₁₂). High purity is understood in the context of the lithium ion battery market as 99% lithium titanate by wt %. It is evident from the data presented in Table 2 that the Washed solids have provided a product with a smaller d50 and a greater surface area.

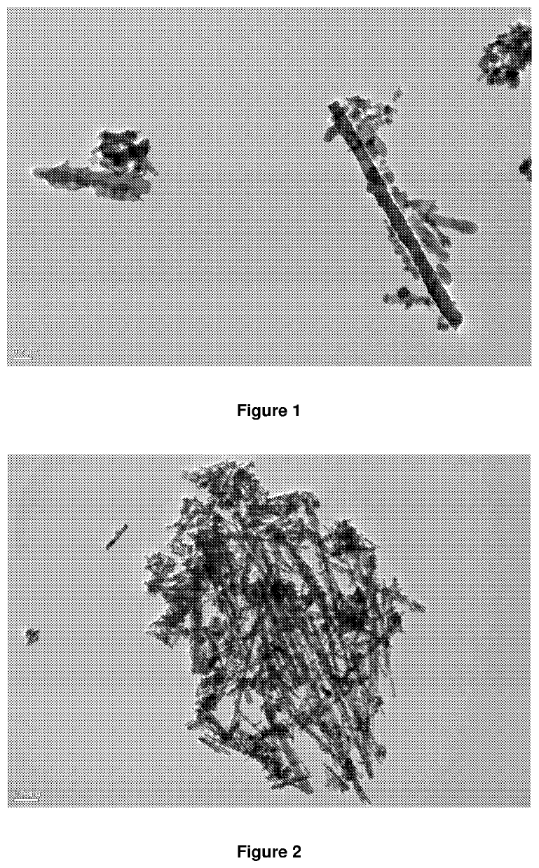

FIGS. 1 and 2 show transmission electron microscopy (TEM) images of the nano-tube type crystal structure of the lithium titanate formed in accordance with the method of the present invention and having a nano-tube type crystal structure, using JOEL 2100 TEM. The legends of FIGS. 1 and 2 denote 0.2 μm and 0.5 μm, respectively.

The product has properties set out in Table 1 below.

TABLE 1

| Test Details | | Calcined/Sintered sample (700° C., 2 h) | | | | | | |
|---|---|---|---|---|---|---|---|---|
| Hydrothermal | Reagents | | | Particle size | Surface area | | | |
| Test no | used | Sample & ID | XRD phase | μm | (BET) m²/g | Li % | Ti % | Na % |
| Hydrom-1 | LiOH & | Unwashed | i) Li₄Ti₅O₁₂ | d50 = 0.833 | 6.56 ± 0.014 | 5.81 | 55.4 | — |
| (180° C.) | Anatase | (Sample | ii) TiO₂ (anatase)* | d80 = 1.337 | | | | |
| | | ID - LTO-2DJ) | iii) TiO₂ (rutile)* | d90 = 1.681 | | | | |
| | | Washed | i) Li₄Ti₅O₁₂ | d50 = 0.451 | 10.22 ± 0.211 | 5.55 | 56.5 | — |
| | | (Sample | ii) TiO₂ (anatase)* | d80 = 0.875 | | | | |
| | | ID - 1W) | iii) TiO₂ (rutile)* | d90 = 1.402 | | | | |
| Hydrom-2 | LiOH & | Unwashed | i) Li₄Ti₅O₁₂ | d50 = 0.458 | 8.89 ± 0.043 | 5.99 | 56.4 | — |
| (135° C.) | Anatase | | ii) TiO₂ (anatase)* | d80 = 0.841 | | | | |
| | | | iii) TiO₂ (rutile)* | d90 = 1.289 | | | | |
| | | Washed | i) Li₄Ti₅O₁₂ | d50 = 0.415 | 10.92 ± 0.229 | 5.57 | 56.9 | — |
| | | (Sample | ii) TiO₂ (anatase)* | d80 = 0.816 | | | | |
| | | ID - 2W) | iii) TiO₂ (rutile)* | d90 = 1.294 | | | | |
| Hydrom-4 | NaOH & | Washed | i) Li₄Ti₅O₁₂ | d50 = 4.019 | 21.85 | 4.43 | 47.8 | 2.1 |
| (150° C.) | Anatase - | (Sample | ii) Un-identified | d80 = 12.335 | | | | |
| | followed by | ID - 4W) | minor peaks | d90 = 19.124 | | | | |
| | LiOH | | | | | | | |
| | treatment | | | | | | | |

Note:
*designates minor phase

For comparison purposes, Table 1 also provides results for an LTO prepared under the same conditions but by the combination of NaOH and anatase TiO₂, followed by treatment with LiOH. Such a process is more complicated/difficult than the method of the present invention and would require significantly greater capital and operating expenditure.

### EXAMPLE 2

A larger sample of high purity lithium titanate (Li₄Ti₅O₁₂) was first prepared by the method described above in Example 1, with weights adjusted to suit. The characterisation of the 750 g of high purity lithium titanate (Li₄Ti₅O₁₂) so produced is set out in Table 2 below.

TABLE 2

| | Autoclave | | | Sintering | | | | | | |
|---|---|---|---|---|---|---|---|---|---|---|
| | conditions | | Li analysis | conditions | | Characterisation data | | | | |
| | Temp. | Time | (autoclave | Temp. | Time | XRD | Particle size | Surface area | | |
| Sample | ° C. | h | final liquor) | ° C. | h | phase | μm | (BET) m²/g | Li % | Ti % |
| 750 g | 135 | 24.0 | 911 mg/L-953 mg/L | 705 | 2.0 | Only LTO | d10 = 0.407 | 13.17 ± 0.253 | 5.90 | 49.80 |
| LTO | | | | | | peaks | d50 = 0.86 | | | |
| | | | | | | | d80 = 1.602 | | | |
| | | | | | | | d90 = 2.659 | | | |

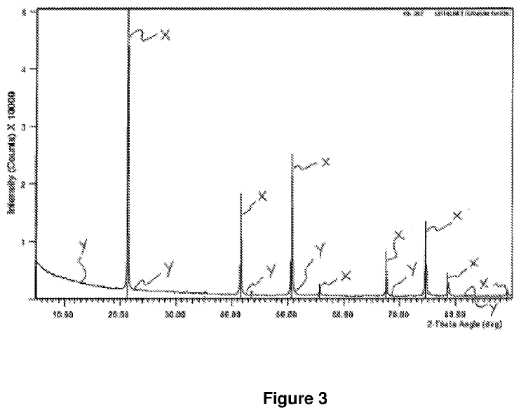

FIG. 3 provides the discrete XRD peaks (each marked X) for the high purity lithium titanate (Li₄Ti₅O₁₂) produced by way of the experimental method described immediately above relative to the profile for a reference LTO (profile curve marked Y). Only LTO peaks are evident.

### Half-Cell Battery Testing

Lithium titanate synthesised in accordance with the method of the present invention has been tested electrochemically by fabricating half cells. The synthesised lithium titanate, having the formula Li₄Ti₅O₁₂ and being in nano-tube type crystal structure, was used as one electrode and lithium metal as the counter electrode in the fabrication of half-cells. The tests have been run at room temperature (22° C.) as well as at high temperature (55° C.) to determine initial capacity, as well as the ability of the material to handle high current densities. The tests have been compared with standard Li₄Ti₅O₁₂ anode material produced in accordance with the prior art and currently available in the market. The tests have shown that Li₄Ti₅O₁₂ formed using the process of the present invention shows far superior electrochemical performance than the standard Li₄Ti₅O₁₂ available commercially at present.

The results are summarised in Table 3 below, wherein ‘Standard’ refers to prior art lithium titanate and ‘2W’ designates lithium titanate synthesised in accordance with the method of the present invention:

TABLE 3
Comparison of Cyclic Data

| Cell Identity: | 2 W | Synthesised by Applicant in accordance with invention | |
|---|---|---|---|
| | Standard | Standard from the market E.g. TRONOX TR-LTO-100 ™ | |
| Tester | NEI CORPORATION, USA | | |
| C Rate | 0.001 | | |
| Ch. max. V | 5.00 V | | |
| DisCh. min. V | −5.00 V | | |
| Ch. max. I | 5.000 A | | |
| DisCh. max. I | 5.000 A | | |
| | Cycle Number | Charge Cap mAh | Disch Cap mAh |
| Standard | 1 | 175.665 | 178.59 |
| 2 W | 1 | 159.03 | 169.8 |
| Standard | 10 | 175.442 | 175.587 |
| 2 W | 10 | 159.056 | 158.927 |
| Standard | 20 | 175.283 | 175.492 |
| 2 W | 20 | 158.9 | 158.752 |
| Standard | 30 | 174.773 | 174.767 |
| 2 W | 30 | 154.383 | 154.202 |
| Standard | 40 | 156.013 | 155.736 |
| 2 W | 40 | 150.598 | 150.599 |
| Standard | 41 | 1.6395 | 156.012 |
| 2 W | 41 | 147.549 | 150.612 |
| Standard | 50 | 0.6004 | 0.6612 |
| 2 W | 50 | 148.105 | 147.892 |

The standard LTO failed after 40 cycles where Applicant's 2W continued to show strong electrochemical performance up to the 50 cycles tested.

As can be seen with reference to the above description, the lithium titanate (Li₄Ti₅O₁₂) synthesised in accordance with the method of the present invention, having nano-tube type crystal structure, shows high battery cycle performance, stable discharge voltage, larger capacity relative to the prior art and is an inert material in terms of reaction with electrolyte. Though the theoretical capacity of lithium titanate (Li₄Ti₅O₁₂) is 180 mAh/g, the range of 150˜170 mAh/ig can readily be achieved, against the lithium electrode potential. The voltage of lithium titanate (Li₄Ti₅O₁₂) anode batteries against lithium metal is 1.55V (that is Li/Li+). During the lithium ion insertion and de-embedding process, the material structure of the electrode remains almost unchanged, consequently demonstrating excellent cycle performance relative to the prior art. It also demonstrates superior battery cycle performance, again relative to the prior art, across the temperature range of minus 30 to 60° C.

Modifications and variations such as would be apparent to the skilled addressee are considered to fall within the scope of the present invention.

1. A method for the synthesis of lithium titanate, the method comprising the method steps of:
(i) reacting a source of titanium ions with a source of lithium ions at increased temperature in one or more reaction vessels for a period of time; and
(ii) calcining the product of step (i) to produce a lithium titanate product having a nano-tube type crystal structure.

2. The method of claim 1, wherein the source of titanium ions used in step (i) is one of the group of titanium dioxide (TiO₂), titanic acid (H₄Ti₅O₁₂), and sodium titanate (Na₄Ti₅O₁₂).

3. The method of claim 2, wherein the source of titanium ions used in step (i) is titanium dioxide (TiO₂) in the anatase form.

4. The method of any one of claims 1 to 3, wherein the source of lithium ions used in step (i) is one of the group of LiOH.H₂O or Li₂CO₃ or LiCl or Li₂SO₄.

5. The method of claim 4, wherein the source of lithium ions used in step (i) is LiOH.H₂₀.

6. The method of any one of the preceding claims, wherein the one or more reaction vessels of step (i) are provided in the form of one or more autoclaves, optionally one or more zirconium autoclaves.

7. The method of any one of the preceding claims, wherein the increased temperature of the reaction of step (i) is in the range of about 135° C. to 180° C.

8. The method of any one of the preceding claims, wherein the period of time of the reaction of step (i) is a period of:
(i) at least several hours;
(ii) greater than 12 hours; or
(iii) about 24 hours.

9. The method of any one of the preceding claims, wherein the calcining of step (ii) takes place at a temperature of:
(i) at least 650° C.; or
(ii) about 700° C.

10. The method of any one of the preceding claims, wherein the calcining of step (ii) takes place over a period of:
(i) greater than 1 hour; or
(ii) about 2 hours.

11. An electrode material for use in lithium ion batteries, the electrode material comprising lithium titanate produced by the method of any one of the preceding claims.

12. The electrode material of claim 11, wherein the electrode material is provided in the form of an anode.

13. The electrode material of claim 11 or 12, wherein the capacity of the lithium titanate electrode material is in the range of 150˜170 mAh/g against lithium electrode potential.

14. The electrode material of claim 13, wherein the charge capacity of greater than or equal to 150 mAh/g against lithium electrode potential is maintained over at least 40 cycles.

15. A lithium ion battery comprising electrode material according to any one of claims 11 to 14.

16. A lithium titanate in nano-tube type crystal form prepared by the method of any one of claims 1 to 10.
